(19) United States
(12) Patent Application Publication
(10) Pub. No.: US 2024/0275457 A1
(43) Pub. Date: Aug. 15, 2024

(54) CHANNEL STATE INFORMATION REPORTING

(71) Applicant: NEC CORPORATION, Tokyo (JP)

(72) Inventors: Gang WANG, Beijing (CN); Yukai GAO, Beijing (CN)

(73) Assignee: NEC CORPORATION, Tokyo (JP)

(21) Appl. No.: 18/568,592

(22) PCT Filed: Jun. 16, 2021
(86) PCT No.: PCT/CN2021/100435

§ 371 Date: Dec. 8, 2023

(51) Int. Cl. H04B 7/06; H04B 17/318

(52) U.S. Cl. CPC H04B 7/0626; H04B 17/328

(57) ABSTRACT

Embodiments of the present disclosure relate to methods, devices and computer readable media for communication. According to embodiments of the present disclosure, a terminal device transmits, to a network device, a channel state information (CSI) report indicating a correspondence between reported values of a plurality of groups of resources and a plurality of channel measurement resource sets configured by the network device. Each of the plurality of groups comprises resources selected from different channel measurement resource sets. In this way, the uplink control information may be used for indicating the CSI at the level of beam pairs with a suitable payload size.

### TECHNICAL FIELD

Embodiments of the present disclosure generally relate to the field of telecommunication, and in particular, to methods, devices and computer storage media for communication.

### BACKGROUND

With the technology of multiple input multiple output (MIMO)s, multi-antenna schemes, such as multi-Transmission and Reception Point (multi-TRP) transmission and/or multi-panel transmission, are widely used for new radio access (NR). A network device may use a large number of antenna elements for communicating with a terminal device.

In the multi-antenna schemes, the network device allocates multiple channel measurement resource (CMR) sets for multi-TRPs. From the perspective of the terminal device, it performs channel measurements on the CMR sets to find an optimal group of beams suitable for multi-TRP. The terminal device may then report channel state information (CSI) to the network device. To improve the report accuracy, there is a demand for reporting CSI at the level of groups of beams.

### SUMMARY

In general, embodiments of the present disclosure provide methods, devices and computer storage media for CSI reporting.

In a first aspect, there is provided a method of communication. The method comprises: transmitting, at a terminal device and to a network device, a channel state information (CSI) report indicating a correspondence between reported values of a plurality of groups of resources and a plurality of channel measurement resource sets configured by the network device, each of the plurality of groups comprising resources selected from different channel measurement resource sets.

In some example embodiments, the correspondence is indicated by a first indicator in the CSI report. The first indicator indicates a channel measurement resource set on which a largest one of the reported values is obtained.

In some example embodiments, the correspondence is indicated by a second indicator in the CSI report. The second indicator indicates a target field for a largest one of the reported values obtained from a channel measurement resource set.

In some example embodiments, the CSI report comprises the following for indicating the correspondence: reported absolute values for measurement results of resources of a first group of the plurality of groups, and reported differences between a larger one of the reported values and the rest of measurement results of resources of the plurality of the groups.

In some example embodiments, the CSI report indicates a correspondence between the plurality of groups of resources and the reported values determined based on averaged measurement results of the plurality of groups of resources.

In some example embodiments, transmitting the CSI report comprises: transmitting a first part of the CSI report comprising a third indicator indicating an existence of a second part of the CSI report, the first part of the CSI report indicates a part of the reported values; and transmitting the second part of the CSI report indicates a rest of the reported values.

In some example embodiments, the CSI report comprises the following for indicating the correspondence: a first reported value for a largest one of measurement results of each group of the resources, and a reported difference between the largest one and the rest of the measurement results of each group of the resources.

In some example embodiments, at least one of the resources corresponds to more than one of the groups, the correspondence is indicated by a plurality of fields in the CSI report, and the plurality of fields indicates at least one reported value of a measurement result of the at least one of the resources.

In some example embodiments, the method further comprises: transmitting, to the network device, capability information of the terminal device in terms of channel measurement; receiving, from the network device, measurement configurations for the channel measurement resource sets based on the capability information; and obtaining, based on the measurement configurations, measurement results of the plurality of groups of resources, the reported value determined based on the measurement results.

In some example embodiments, the reported values comprise at least one of the following: absolute or differential values determined based on reference signal received powers (RSRPs), reference signal received qualities (RSRQs), or signal to interference plus noise ratios (SINRs) measured from the reference signals.

In a second aspect, there is provided a method of communication. The method comprises: receiving, at a network device and from a terminal device, a channel state information (CSI) report indicating a correspondence between reported values of a plurality of groups of resources and a plurality of channel measurement resource sets configured by the network device, each of the plurality of groups comprising resources selected from different channel measurement resource sets.

In some example embodiments, the correspondence is indicated by a first indicator in the CSI report, and the first indicator indicates a channel measurement resource set on which a largest one of the reported values is obtained.

In some example embodiments, the correspondence is indicated by a second indicator in the CSI report, and the second indicator indicates a target field for a largest one of the reported values obtained from a channel measurement resource set.

In some example embodiments, the CSI report comprises the following for indicating the correspondence: reported values for measurement results of resources of a first group of the plurality of groups, and reported differences between a larger one of the reported values and the rest of measurements results of resources of the plurality of the groups.

In some example embodiments, the CSI report indicates a correspondence between the plurality of groups of resources and the reported values determined based on averaged measurement results of the plurality of groups of resources.

In some example embodiments, receiving the CSI report comprises: receiving a first part of the CSI report comprising a third indicator indicating an existence of a second part of the CSI report, the first part of the CSI report indicates a part of the reported values; and receiving the second part of the CSI report indicates a rest of the reported values.

In some example embodiments, the CSI report comprises the following for indicating the correspondence: a first reported value for a largest one of measurement results of each group of the resources, and a reported difference between the largest one and the rest of the measurement results of each group of the resources.

In some example embodiments, at least one of the resources corresponds to more than one of the groups, the correspondence is indicated by in the CSI report, and the plurality of fields indicates at least one reported value of a measurement result of the at least one of the resources.

In some example embodiments, the method further comprises: receiving, from the terminal device, capability information of the terminal device in terms of channel measurement; and transmitting, to the terminal device, measurement configurations for the channel measurement resource sets based on the capability information.

In some example embodiments, the reported values comprise at least one of the following: absolute or differential values determined based on reference signal received powers (RSRPs), reference signal received qualities (RSRQs), or signal to interference plus noise ratios (SINRs) measured from the reference signals.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first or second aspect of the present disclosure.

In a sixth aspect, there is provided a terminal device. The terminal device comprises circuitry, configured to perform the method according to the first aspect of the present disclosure.

In a seventh aspect, there is provided a terminal device. The network device comprises circuitry, configured to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication system in which embodiments of the present disclosure can be implemented;

FIG. 1B illustrates a schematic diagram of channel measurement resource (CMR) sets configured for the multi-TRP transmission according to some example embodiments of the present disclosure;

FIG. 2 illustrates a signaling flow for communication according to some example embodiments of the present disclosure;

FIG. 3 illustrates a flow chart of an example method of communication implemented at a terminal device in accordance with some embodiments of the present disclosure;

FIG. 4 illustrates a flow chart of an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In the following, the terms “PUSCH transmission”, “PUSCH transmission occasion”, “uplink transmission”, “PUSCH repetition”, “PUSCH occasion” and “PUSCH reception” can be used interchangeably. The terms “transmission”, “transmission occasion” and “repetition” can be used interchangeably. The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably. The terms “SRI”, “SRS resource set index”, “UL TCI”, “UL spatial domain filter”, “UL beam”, “joint TCI” can be used interchangeably.

Generally speaking, one TRP usually corresponds to one CMR set. As used herein, the term “single-TRP” refers to that a single CMR set is used for performing related channel measurements (such as, PUSCH transmissions), and the term “multi-TRP” refers to that a plurality of CMR sets is used for performing related channel measurements.

In legacy communication network, prior to CSI reporting, the terminal device may inform the network device of the terminal device's capability in terms of channel measurement. The network device may configure CSI related configurations based on the terminal device's capability, and then transmit the same to the terminal device via a radio resource control (RRC) message. The terminal device may then perform beam measurement and CSI reporting by using the CSI related configurations. Typically, the CSI report corresponds to a single CSI resource set, such as, a CMR set. The CSI report in a conventional format may include, for example, CSI reference signal resource indicator (CRI), SS/PBCH Block Resource Indicator (SSB-RI), and reported values determined based on the measurement results of the CSI resource set. The reported values may include a 7-bit value indicative of a highest measurement result, such as, a reference signal received power (RSRP), a reference signal received quality (RSRQ), or a signal to interference plus noise ratio (SINR) measured from the reference signals, and at least one reported difference between the larger one of the reported values and the rest of measurements results. The quantization range within a single group of resources is 30 dB.

In Release-17, multi-TRP transmissions are supported for improving communications between the network device and the terminal device. In this case, the network device may configure a plurality of CSI resource sets for the multiple TRPs, and each of the CSI resource sets may include a plurality of resources. To find best beams suitable for the multi-TRPs, the terminal device may perform beam measurements on different groups of resources, each of the groups includes resources selected from different CSI resource sets.

By way of example, the network device may configure two CMR sets for two TRPs, and each of the CMR sets includes multiple resources, for example, eight resources. The terminal device may perform beam measurements on the configured CMR sets and report two groups of resources selected from the CMR sets. In this example, two groups of resources or the beams groups are reported via a single CSI report. However, according to the CSI report of the conventional format, the highest reported value is linked to the first CRI which may correspond to either of the CMR sets. As a result, there is no CMR set information or TRP information reflected in the CSI report.

In a case of a relatively large number of the groups of resources or the beams groups to be reported, it may cause a substantial payload size of uplink control information (UCI). Further, since the reported differential values are calculated with a reference to the highest reported value, if two groups of resources are reported, the quantization range within the second group would be restricted to be less than 30 dB, which may affect the report accuracy.

In order to solve at least part of above problems, solutions on channel state information reporting are proposed. According to embodiments of the present disclosure, a terminal device transmits, to a network device, a CSI report indicating a correspondence between reported values of a plurality of groups of resources and a plurality of CMR sets configured by the network device. Each of the plurality of groups includes resources selected from different channel measurement resource sets. As such, the CSI report can provide information about multiple groups of beams which are from different CMR sets with a suitable payload size. Upon receipt of the CSI report, the network device may adjust scheduling and configurations of the transmission with the terminal device.

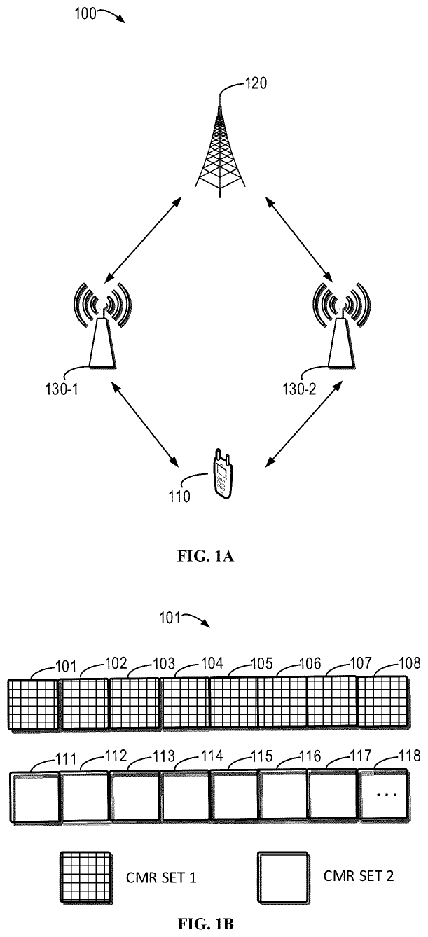

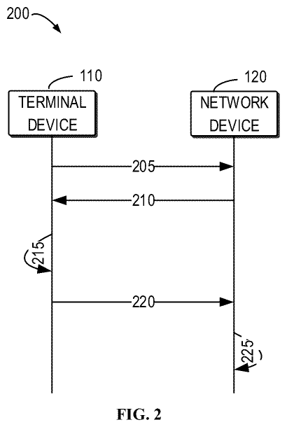

FIG. 1A illustrates an example communication system 100 in which embodiments of the present disclosure can be implemented. The communication system 100, which is a part of a communication network, comprises a terminal device 110, a network device 120, and a plurality of TRPs 130-1 and 130-2, which may be collectively referred to as “TRP(s) 130.”

The network device 120 serves the terminal device 110, and the terminal device 110 may communicate with the network device 120 via one or more physical communication channels or links. In the communication network 100, a link from the terminal device 110 to the network device 120 is referred to as an uplink (UL), while a link from the network device 120 to the terminal device 110 is referred to as a downlink (DL). In UL, the terminal device 110 is a TX device (or a transmitter) and the network device 120 is a RX device (or a receiver). In DL, the network device 120 is a transmitting (TX) device (or a transmitter) and the terminal device 110 is a receiving (RX) device (or a receiver).

In order to support multi-TRP and/or multi-panel, the network device may be equipped with one or more TRPs. For example, the network device 120 may be coupled with TRPs 130-1 and 130-2 in different geographical locations to achieve better coverage. One or more TRPs of the multiple TRPs may be included in a same serving cell or different serving cells. It is to be understood that the TRP can also be a panel, and the panel can also refer to an antenna array (with one or more antenna elements).

In addition, the terminal device 110 may be configured with a higher layer parameter repetition. The higher layer parameter repetition is set per CMR set, and indicates whether the resources in a CMR set are transmitted with the same spatial domain transmission filter. Specifically, if the higher layer parameter repetition is set to ‘ON’, and the terminal device 110 may assume that the CSI-RS resources in a corresponding CMR set are transmitted with the same DL spatial domain transmission filter, where the CSI-RS resources are transmitted in different OFDM symbols. Otherwise, if the higher layer parameter repetition is set to ‘OFF’, the terminal device 110 may not assume that the CSI-RS resources in the corresponding CMR set are transmitted with the same DL spatial domain transmission filter.

The network device 120 may configure a plurality of CMR sets, each of which includes a plurality of resources and corresponds to a respective TRP. The terminal device 110 may be configured to report N beam pairs that correspond to N groups of resources, and each group includes resources from different CMR sets.

FIG. 1B illustrates a schematic diagram of CMR sets configured for the multi-TRP transmission according to some example embodiments of the present disclosure. In the example shown in FIG. 1B, the network device 120 configures two CMR sets for the two TRPs 130-1 and 130-2, namely, CMR set 1 and CMR set 2. For example, the CMR set 1 may be configured for the TRP 130-1 and include resources 101 to 108, and the CMR set 2 may be configured for the TRP 130-2 and include resources 111 to 118. The resources 101 to 108 and 111 to 118 may be CSI-RS resources. The terminal device 110 may perform measurements on the CMR sets 1 and 2 and report for N groups of resources with each group including two beams, where N=2.

It should be understood that the number N=2 and each of the CMR sets #1 and #2 including eight CSI-RS resources are only given as one of the possible configurations. The numbers N can be any suitable integer number not less than two, and the CMR set 1 includes K1 CSI-RS resources, while the CMR set 2 includes K2 CSI-RS resources, where K1>K2.

The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure. It would also be appreciated that in some examples, only the homogeneous network deployment or only the heterogeneous network deployment may be included in the communication network 100.

FIG. 2 illustrates a signaling flow for communication according to some example embodiments of the present disclosure. Only for the purpose of discussion, the process 200 will be described with reference to FIGS. 1A-1B. The process 200 may involve the terminal device 110, the network device 120 and the TRPs 130. It should be noted that the process 200 is only an example not limitation.

The terminal device 110 may transmit 205, to the network device 120, capability information of the terminal device 110 in terms of channel measurement. For example, the capability information may indicate the CSI related capability of the terminal device 110 that whether the terminal device 110 supports the CSI reporting at the level of beam pairs or groups of CSI-RS resources.

The network device 120 may determine measurement configurations for the terminal device 110 based on the received capability information. For example, the measurement configurations may be CSI related configurations, which include but not limited to, the CMR sets, the report quantity, the report frequency configuration, CSI reporting band, time restriction for channel measurements and so on.

The network device 120 may transmit 210 the measurement configurations for the CMR sets to the terminal device 110. For example, the transmission of the measurement configurations may be via a RRC message. The network device 120 may then transmit CSI-RSs based on the measurement configurations.

Upon receipt of the measurement configurations, the terminal device 110 may perform channel measurements (e.g., beam measurements) on a plurality of groups of resources, and each group includes resources selected from different channel measurement resource sets. In the context of the present disclosure, the resources in the CMR sets may be designated as CRI #m, where m=Σₙ₌₁^{N}Mₙ₋₁+1, . . . , Σₙ₌₁^{N}Mₙ forms group n, for each n=1, . . . , N, where N represents the number of groups of resources, Mₙ represents the number of beams in each group, and M₀=0. For example, {CRI #m, m=1, . . . , M₁} may form a first group, and {CRI #m, m=M₁+1, . . . , M₁+M₂} may form a second group. It should be understood that the group n may also be formed as {CRI #m, m=n, N+n . . . , Mₙ*N+n}, for each n=1, . . . , N. The present disclosure is not limited in this regard.

The terminal device 110 may obtain measurement results of the plurality of groups of resources. In some example embodiments, the measurement results may include but not limited to, RSRPs, RSRQs, SINRs and the like. The terminal device 110 may determine 215 values to be reported in the CSI report based on the measurement results.

The terminal device 110 transmits 220 the CSI report to the network device 120. The CSI report indicates a correspondence between the reported values of a plurality of groups of resources and a plurality of channel measurement resource sets configured by the network device 120. In other words, the CSI report provides CMR set information about each of the groups of resources. Examples of CSI report will be discussed below in details.

In the example shown in FIGS. 1A-1B, the resources 102, 104, 112 and 114 may be designated as CRI #1, CRI #2, CRI #3 and CRI #4. The first group of resources may include resources 102 and 112, and the second group of resources may include resources 104 and 114.

The CSI report may include a highest reported value measured on the resource CRI #1. As discussed above, the highest reported value may correspond to either the resources in CMR set 1 or the resources in CMR set 2. In some example embodiments, the correspondence may be indicated by a first indicator in the CSI report. The first indicator may indicate a CMR set on which the largest one of the reported values is obtained. For example, a value of the first indicator may indicate a highest reported value is measured on the CMR set 1 or the CMR set 2.

In example embodiments where all the CRI(s) are to be reported by the terminal device 110, if the highest reported RSRP value is measured on the resource from the CMR set 1, the first indicator may be set to the first value (e.g., 0), the bitwidth of the field for CRI #1 is ┌log₂(K1)┐. Otherwise, if the highest reported RSRP value is measured on the resource from the CMR set 2, the first indicator may be set to the second value different from the first value (e.g., 1), the bitwidth of the field for CRI #1 is ┌log₂(K2)┐, and the bitwidth of the field for CRI #2 is ┌log₂(K1)┐. In other words, the first indicator is configured for indicating whether the field for CRI #1 points to the resource in CMR set 1 or in CMR set 2. Table 1 shows an example of the CSI report with the first indicator as below.

TABLE 1
The CSI report with the first indicator

| Fields in the | Bitwidth when the | Bitwidth when the |
|---|---|---|
| CSI report | first indicator = 0 | first indicator = 1 |
| First Indicator | 1 | 1 |
| CRI#1 | ┌log₂(K1)┐ | ┌log₂(K2)┐ |
| CRI#2 | ┌log₂(K2)┐ | ┌log₂(K1)┐ |
| CRI#3 | ┌log₂(K1)┐ | ┌log₂(K2)┐ |
| CRI#4 | ┌log₂(K2)┐ | ┌log₂(K1)┐ |
| RSRP#1 | 7 | 7 |
| Differential RSRP#2 | 4 | 4 |
| Differential RSRP#3 | 4 | 4 |
| Differential RSRP#4 | 4 | 4 |

In some example embodiments, none of the CRI(s) is to be reported, or only a subset of the CRI(s) are to be reported. For example, in Release 15/16, if the CRI-RSRP or CRI-SINR is configured to be reported, and the higher layer parameter repetition is set to ‘ON’, the terminal device 110 may not report the CRI. In these embodiments, if the highest reported RSRP value is measured on the resource from the CMR set 1, the first indicator may be set to the first value (e.g., 0). Otherwise, if the highest reported RSRP value is measured on the resource from the CMR set 2, the first indicator may be set to the second value different from the first value (e.g., 1). Table 2 shows another example of the CSI report with the first indicator as below.

TABLE 2
The CSI report with the first indicator

| | Bitwidth for | Bitwidth for | | |
|---|---|---|---|---|
| | reporting | reporting a | | |
| Fields in the | none of the | subset of the | When first | When first |
| CSI report | CRI (s) | CRI (s) | indicator = 0 | indicator = 1 |
| First indicator | 1 | 1 | | |
| CRI#1 | Not reported | Not reported | | |
| CRI#2 | Not reported | ┌log₂(K2)┐ | | |
| CRI#3 | Not reported | Not reported | | |
| CRI#4 | Not reported | ┌log₂(K2)┐ | | |
| RSRP#1 | 7 | 7 | Measured on | Measured on |
| | | | CMR set 1 | CMR set 2 |
| Differential | 4 | 4 | Measured on | Measured on |
| RSRP#2 | | | CMR set 2 | CMR set 1 |
| Differential | 4 | 4 | Measured on | Measured on |
| RSRP#3 | | | CMR set 1 | CMR set 2 |
| Differential | 4 | 4 | Measured on | Measured on |
| RSRP#4 | | | CMR set 2 | CMR set 1 |

It should be understood that the specific values of the first value and second value of the first indicator in the above embodiments are given as an example, and any other value is also possible. Moreover, the number of bits for the first indicator may vary depending on the bitwidth and the number of the CMR sets configured by the network device 120. For example, the number of bits for the first indicator may be designated as ┌log₂(number of CMR sets)┐. The present disclosure is not limited in this regard.

In some example embodiments, the fields for CRIs and the reported values in the CSI report are fixed. For example, the field CRI #1 may correspond to the resource 102 in CMR set 1 with a bitwidth of ┌log₂(K1)┐, the field CRI #2 may correspond to the resource in 112 CMR set 2 with a bitwidth of ┌log₂(K2)┐, and so on. In addition, the field RSRP #1 may correspond to a reported value determined based on a measurement result obtained on the resource corresponding to CRI #1, and so on.

In the above embodiments, the correspondence may be indicated by a second indicator in the CSI report. The second indicator may indicate a target field for a largest one of the reported values. If all the CRI(s) are to be reported by the terminal device 110, the second indicator may indicate whether the resource corresponding to the CRI #1 has the highest reported value. A first value of the second indicator (e.g., 0) may indicate that the field RSRP #1 is mapped first with a bitwidth of 7 bits, which corresponds to CRI #1 and indicates the highest RSRP. The field differential RSRP #2 is followed with a bitwidth of 4 bits. A second value of the second indicator (e.g., 1) may indicate that the field differential RSRP #1 is mapped first with a bitwidth of 4 bits, and the field RSRP #2 is followed with a bitwidth of 7 bits, which corresponds to CRI #2 and indicates the highest RSRP. In other words, the second indicator may be configured for indicating a mapping position of the filed for the highest RSRP. Table 3 shows an example of the CSI report with the second indicator as below.

TABLE 3
The CSI report with the second indicator

| Fields in the CSI report | Fields in the CSI report | Bitwidth |
|---|---|---|
| CRI#1 | CRI#1 | ┌log₂(K1)┐ |
| CRI#2 | CRI#2 | ┌log₂(K2)┐ |
| CRI#3 | CRI#3 | ┌log₂(K1)┐ |
| CRI#4 | CRI#4 | ┌log₂(K2)┐ |
| When Second Indicator = 0 | When Second Indicator = 1 | 1 |
| RSRP#1 | Differential RSRP#1 | 7 or 4 |
| Differential RSRP#2 | RSRP#2 | 4 or 7 |
| Differential RSRP#3 | Differential RSRP#3 | 4 |
| Differential RSRP#4 | Differential RSRP#4 | 4 |

In some example embodiments, none of the CRI(s) is to be reported, or only a subset of the CRI(s) is to be reported. Likewise, a first value of the second indicator (e.g., 0) may indicate that the field RSRP #1 is mapped first with a bitwidth of 7 bits, and the field differential RSRP #2 is followed with a bitwidth of 4 bits. A second value of the second indicator (e.g., 1) may indicate that the field differential RSRP #1 is mapped first with a bitwidth of 4 bits, and the field RSRP #2 is followed with a bitwidth of 7 bits.

In some example embodiments, the fields for CRIs and the reported values in the CSI report are fixed, and the CSI report may include the following for indicating the correspondence:
reported absolute values for measurement results of resources of the first group of the plurality of groups, and each of the absolute values is reported in a corresponding 7-bit field, and
reported differences between a larger one of the reported values and the rest of measurements results of resources of the plurality of the groups, and each of the differences is reported in a corresponding 4-bit field.

Table 4 shows an example of the CSI report with extended fields for reported values as below. As shown, the field CRI #1 may correspond to the resource 102 in CMR set 1 with a bitwidth of ┌log₂(K1)┐, the field CRI #2 may correspond to the resource 112 in CMR set 2 with a bitwidth of ┌log₂(K2)┐, and so on. The field RSRP #1 may correspond to a 7-bit reported value determined based on a measurement result obtained on the resource 102 corresponding to CRI #1, and the field RSRP #2 may correspond to a 7-bit reported value determined based on a measurement result obtained on the resource 112 corresponding to CRI #2. In addition, the 4-bit field differential RSRP #3 may correspond to the reported difference between the measurement result obtained on the resource 104 with respect to a larger one of the fields RSRP #1 and RSRP #2, and the 4-bit field differential RSRP #4 may correspond to the reported difference between the measurement result obtained on the resource 114 with respect to the larger one of the fields RSRP #1 and RSRP #2.

TABLE 4
The CSI report with extended fields for reported values

| Fields in the CSI report | Bitwidth |
|---|---|
| CRI#1 | ┌log₂(K1)┐ |
| CRI#2 | ┌log₂(K2)┐ |
| CRI#3 | ┌log₂(K1)┐ |
| CRI#4 | ┌log₂(K2)┐ |
| RSRP#1 | 7 |
| RSRP#2 | 7 |
| Differential RSRP#3 with | 4 |
| respect to max (RSRP#1, RSRP#2) | |
| Differential RSRP#4 with | 4 |
| respect to max (RSRP#1, RSRP#2) | |

In some example embodiments, the CSI report may indicate a correspondence between the plurality of groups of resources and the reported values determined based on averaged measurement results of the plurality of groups of resources. For example, the CSI report may index combinations of resources in order of group of resources. Additionally, or alternatively, the CSI report may also accommodate that no RSRP is reported, or two RSRPs are reported per combination. Such a CSI report may reduce the payload size, and it may be especially beneficial when the network device 120 does not focus on which of the TRPs has the best beam, but is interested in the best beam pair.

Table 5 shows an example of the CSI report with combinational indexes and reported values for groups of resources as below. The combinational indexes may be used to index the resources to be one-to-one combinations for resources in CMR set 1 and CMR set 2. The ordering for the combinations for resources may be, for example, {(resource 101, resource 111), (resource 102, resource 112), . . . , (resource 108, resource 118)}, where a combinational index 0 may represent the combination of (resource 101, resource 111) and so on. As shown, the field Group #1 may correspond to the first group of resources 102 and 112, and the field Group #2 may correspond to the second group of resources 104 and 114. Moreover, the field average RSRP #1 may indicate the average RSRP for the first group corresponding to the field Group #1, and the field average differential RSRP #2 may indicate the average differential RSRP between the average RSRP for the second group and the average RSRP for the first group.

TABLE 5
The CSI report with group indexes and
reported values for groups of resources

| Fields in the CSI report | Bitwidth |
|---|---|
| Group#1 | ┌log₂(K1 * K2)┐ |
| Group#2 | ┌log₂(K1 * K2)┐ |
| Average RSRP#1 | 7 |
| Average differential RSRP#2 | 4 |

In the above embodiments, if the higher layer parameter repetition is set to ‘ON’ for both of the CMR sets 1 and 2, the group indexes would not be reported. If the higher layer parameter repetition is set to ‘ON’ for the CMR set 1, the group indexes may consist only of CRIs in CMR set 2.

In some example embodiments, the CSI report may include a first part and optionally a second part. The terminal device 110 may use a third indicator to indicate whether the second part of CSI report exists or not. Such a two-part format of CSI report may be beneficial to the case where a large number of TRPs or beams are used for the communications between the terminal device 110 and the network device 120.

For example, if the number of groups of resources exceeds a predetermined threshold (e.g., 1, 2, and etc.), the terminal device 110 may use the two-part format of CSI report, and the first part of the CSI report may include the third indicator for indicating the existence of the second part of the CSI report. For another example, in a case where no more than two groups of resources are found, the terminal device 110 may transmit the first part of the CSI report that informs the network device 120 of no second part to be reported.

In some example embodiments, the terminal device 110 may determine whether to omit the second part of the CSI report according to a priority rule. For example, the priority rule may define that the group of resources n has a lower priority than the group of resources n−1, or alternatively, the beam pair #3 and #4 has a lower priority than the beam pair #1 and #2.

In a case where the first part of the CSI report includes a part of the reported values and the third indicator, the terminal device 110 may then transmit the second part of the CSI to the network device 120 for reporting a rest of the reported values. Table 6 shows an example of the two-part format of CSI report.

TABLE 6
The two-part format of CSI report

| CSI report number | Fields in the CSI report |
|---|---|
| CSI report#n | CRI#1, if reported |
| The first part | CRI#2, if reported |
| of the CSI report | CRI#3, if reported |
| | CRI#4, if reported |
| | RSRP#1, if reported |
| | Differential RSRP#2, if reported |
| | Differential RSRP#3, if reported |
| | Differential RSRP#4, if reported |
| | The third indicator for the second |
| | part of CSI report, if reported |
| CSI report#n | CRI#5, if reported |
| The second part | CRI#6, if reported |
| of the CSI report | CRI#7, if reported |
| | CRI#8, if reported |
| | Differential RSRP#5, if reported |
| | Differential RSRP#6, if reported |
| | Differential RSRP#7, if reported |
| | Differential RSRP#8, if reported |

As shown in Table 6, the first part of CSI report may be configured for reporting a first half of the reported groups of resources, and the second part of the CSI report may be configured for reporting a second half of the reported groups of resources. Alternatively, the first part of CSI report may be configured for reporting a first half of the resources in each CMR set, and the second part of the CSI report may be configured for reporting a second half of the resources in each CMR set.

In some example embodiments, the CSI report may have an extended quantization range for the reported values. For example, the CSI report include the following for indicating the correspondence:
a first reported value for a largest one of measurement results of each group of the resources, and
a reported difference between the largest one and the rest of the measurement results of each group of the resources.

In such a CSI report, the reported differential RSRP may be calculated with respect to the largest RSRP within each group of the resources. Table 7 shows an example of the CSI report with an extended quantization range. As shown in Table 7, the field RSRP #1 indicates the highest reported RSRP. Instead of reporting all the differential RSRPs calculated with respect to the highest reported RSRP, the field Differential RSRP #4 indicates the differential RSRP calculated with respect to the highest RSRP #3 within the same group of resources.

TABLE 7
The CSI report with an extended quantization range

| Fields in the CSI report | Bitwidth |
|---|---|
| CRI#1 | ┌log₂(K1)┐ |
| CRI#2 | ┌log₂(K2)┐ |
| CRI#3 | ┌log₂(K1)┐ |
| CRI#4 | ┌log₂(K2)┐ |
| RSRP#1 | 7 |
| Differential RSRP#2 | 4 |
| Differential RSRP#3 | 4 |
| Differential RSRP#4 with | 4 |
| respect to RSRP#3 | |

Table 8 shows another example of the CSI report with an extended quantization range. As shown, the CSI report may indicate the highest reported values for respective groups of resources in the fields RSRP #1 and RSRP #3. For example, each of the fields RSRP #1 and RSRP #3 may include 7 bits.

TABLE 8
The CSI report with an extended quantization range

| Fields in the CSI report | Bitwidth |
|---|---|
| CRI#1 | ┌log₂(K1)┐ |
| CRI#2 | ┌log₂(K2)┐ |
| CRI#3 | ┌log₂(K1)┐ |
| CRI#4 | ┌log₂(K2)┐ |
| RSRP#1 | 7 |
| Differential RSRP#2 | 4 |
| RSRP#3 | 7 |
| Differential RSRP#4 with | 4 |
| respect to RSRP#3 | |

As previously discussed, the conventional CSI report has a quantization range for a single group of resources. Table 9 shows a CSI report with a legacy quantization range 30 dB with a step size of 2 dB, for example.

TABLE 9
The CSI report with a legacy quantization range

| Differential RSRP | |
|---|---|
| field in the CSI report | Measured quantity value |
| 0000 | 0 ≥ ΔRSRP > −2 |
| 0001 | −2 ≥ ΔRSRP > −4 |
| 0010 | −4 ≥ ΔRSRP > −6 |
| . . . | . . . |
| 1101 | −26 ≥ ΔRSRP > −28 |
| 1110 | −28 ≥ ΔRSRP > −30 |
| 1111 | −30 ≥ ΔRSRP |

For the CSI report for a plurality of groups of resources, the same beam may be selected in more than one beam pairs. In this case, there may be more than one field for the same resource corresponding to the beam. In some example embodiments, at least one of the resources corresponds to more than one of the groups. As a result, the corresponding fields may be used for improving the resolution and/or range of the reported values.

In these embodiments, the correspondence may be indicated by a plurality of fields in the CSI report, and the plurality of fields may indicate at least one reported value of a measurement result of the at least one of the resources. Table 10 shows an example of such a CSI report. As shown in table 10, both of the fields CRI #1 and CRI #3 correspond to the same resource, where the reported value for the measurement result of the resource indicated in the field CRI #1 is an absolute value of RSRP. In this example, there are (7+4) bits in total. As compared with the conventional CSI report, 4 more bits may be used for representing a much larger number of states, which can be used to improve the resolution and/or extend the quantization range.

TABLE 10
The CSI report with more than one field for the same resource

| Fields in the CSI report | Bitwidth |
|---|---|
| CRI#1 | ┌log₂(K1)┐ |
| CRI#2 | ┌log₂(K2)┐ |
| CRI#3 corresponding to the | ┌log₂(K1)┐ |
| same resource as CRI#1 | |
| CRI#4 | ┌log₂(K2)┐ |
| RSRP#1-part 1 | 7 |
| Differential RSRP#2 | 4 |
| RSRP#1-part 2 | 4 |
| Differential RSRP#4 | 4 |

As a more general example, it can be quantized by (3+k*4) bits, where k is the number of CRIs to be reported that correspond to the same resource. In some other example embodiments, not all of the CRIs are to be reported, k may be considered as equal as the configured number of beam pairs to be reported, i.e., k=N.

Table 11 shows another example of the CSI report with more than one field for the same resource. As shown in table 11, both of the fields CRI #2 and CRI #4 correspond to the same resource, where the reported value for the measurement result of the resource indicated in the field CRI #2 is a differential value of RSRP. In this example, there are (4+4) bits in total. As compared with the conventional CSI report, 4 more bits may be used for representing a much larger number of states, which can be used to improve the resolution and/or extend the quantization range.

TABLE 11
The CSI report with more than one field for the same resource

| Fields in the CSI report | Bitwidth |
|---|---|
| CRI#1 | ┌log₂(K1)┐ |
| CRI#2 | ┌log₂(K2)┐ |
| CRI#3 | ┌log₂(K1)┐ |
| CRI#4 corresponding to the | ┌log₂(K2)┐ |
| same resource as CRI#2 | |
| RSRP#1 | 7 |
| Differential RSRP#2-part 1 | 4 |
| Differential RSRP#3 | 4 |
| Differential RSRP#2-part 2 | 4 |

Table 12 shows a CSI report with a resolution improved to a step size of 1 dB.

TABLE 12
The CSI report with an improved resolution

| Differential RSRP | |
|---|---|
| field in the CSI report | Measured quantity value |
| 0000 0000 | 0 ≥ ΔRSRP > −1 |
| 0000 0001 | −1 ≥ ΔRSRP > −2 |
| 0000 0010 | −2 ≥ ΔRSRP > −3 |
| . . . | . . . |
| 0001 1101 | −28 ≥ ΔRSRP > −29 |
| 0001 1110 | −29 ≥ ΔRSRP > −30 |
| 0001 1111 | −30 ≥ ΔRSRP |
| Reserved | |
| . . . | |
| Reserved | |

Table 13 shows a CSI report with an extended quantization range of 60 dB.

TABLE 13
The CSI report with an extended quantization range

| Differential RSRP | |
|---|---|
| field in the CSI report | Measured quantity value |
| 0000 0000 | 0 ≥ ΔRSRP > −2 |
| 0000 0001 | −2 ≥ ΔRSRP > −4 |
| 0000 0010 | −4 ≥ ΔRSRP > −6 |
| . . . | . . . |
| 0001 1101 | −56 ≥ ΔRSRP > −58 |
| 0001 1110 | −58 ≥ ΔRSRP > −60 |
| 0001 1111 | −60 ≥ ΔRSRP |
| Reserved | |
| . . . | |
| Reserved | |

It should be understood that numbers and values shown in above Tables 1-13 are given as examples without limitation. In addition, the RSRP is given as an example of the reported values of measurement results of the CMR sets. The reported values may also be absolute or differential values determined based on the reference signal received qualities (RSRQs), or the signal to interference plus noise ratios (SINRs) measured from the reference signals.

Upon receipt of the CSI report, the network device 120 may be aware of CMR set information about the beam pairs/groups of resources. As such, the network device 120 may adjust 225 the scheduling and configurations of the transmission with the terminal device 110.

In this way, the uplink control information may be used for reporting multiple beam pairs and the best beam pair suitable for the multi-TRP. Further, the UCI can indicate a correspondence between the groups of resources and the channel measurement resource sets with a reduced payload size. As such, the report accuracy can be improved.

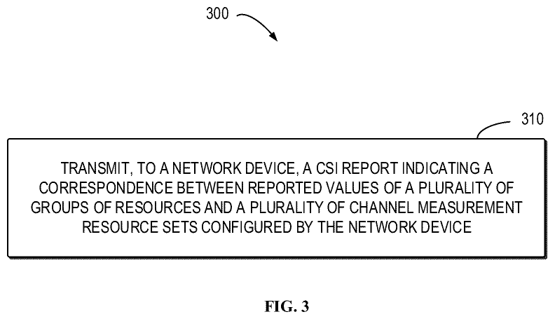

FIG. 3 illustrates a flow chart of an example method 300 of communication implemented at a terminal device in accordance with some embodiments of the present disclosure. The method 300 can be implemented at the terminal device 110 as shown in FIG. 1A. It is to be understood that the method 300 may include additional blocks not shown and/or may omit some blocks as shown, and the scope of the present disclosure is not limited in this regard.

Prior to channel measurement, the terminal device 110 may transmit, to the network device 120, capability information of the terminal device 110 in terms of channel measurement. For example, the capability information may indicate whether the terminal device 110 supports the CSI reporting at the level of beam pairs or groups of CSI-Rs resources.

The network device 120 may determine measurement configurations for the terminal device 110 based on the received capability information. For example, the measurement configurations may be CSI related configurations, which include but not limited to, the CMR sets, the report quantity, the report frequency configuration, CSI reporting band, time restriction for channel measurements and so on.

The network device 120 may transmit the measurement configurations for the CMR sets to the terminal device 110. For example, the transmission of the measurement configurations may be via a RRC message. The network device 120 may then transmit CSI-RSs based on the measurement configurations.

The terminal device 110 may measure the CSI-RSs and obtain measurement results of the plurality of groups of resources based on the measurement configurations. The reported value may be determined based on the measurement results.

At block 310, the terminal device 110 transmits, to the network device 120, a CSI report indicating a correspondence between reported values of a plurality of groups of resources and a plurality of channel measurement resource sets configured by the network device 120. Each of the plurality of groups may include resources selected from different channel measurement resource sets.

In some example embodiments, the correspondence may be indicated by a first indicator in the CSI report. The first indicator may indicate a channel measurement resource set on which a largest one of the reported values is obtained.

In some example embodiments, the correspondence may be indicated by a second indicator in the CSI report. The second indicator may indicate a target field for a largest one of the reported values.

In some example embodiments, the CSI report comprises the following for indicating the correspondence: reported values for measurement results of resources of a first group of the plurality of groups, and reported differences between a larger one of the reported values and the rest of measurements results of resources of the plurality of the groups.

In some example embodiments, the CSI report may indicate a correspondence between the plurality of groups of resources and the reported values determined based on averaged measurement results of the plurality of groups of resources.

In some example embodiments, the CSI report may include a first part and optionally a second part. In these embodiments, the terminal device 110 may transmit the first part of the CSI report comprising a third indicator indicating an existence of a second part of the CSI report. The first part of the CSI report may indicate a part of the reported values. The terminal device 110 may then transmit the second part of the CSI report indicates a rest of the reported values.

In some example embodiments, the CSI report comprises the following for indicating the correspondence: a first reported value for a largest one of measurement results of each group of the resources, and a reported difference between the largest one and the rest of the measurement results of each group of the resources.

In some example embodiments, at least one of the resources may correspond to more than one of the groups, the correspondence is indicated by a plurality of fields in the CSI report. The plurality of fields may indicate at least one reported value of a measurement result of the at least one of the resources.

In some example embodiments, the reported values may comprise at least one of the following: absolute or differential values determined based on reference signal received powers (RSRPs), reference signal received qualities (RSRQs), or signal to interference plus noise ratios (SINRs) measured from the reference signals.

According to the example embodiments of the present disclosure, there is provided a solution of beam reporting. The CSI report is improved to report multiple beam pairs and the best beam pair suitable for the multi-TRP. Moreover, the CSI report can indicate a correspondence between the groups of resources and the channel measurement resource sets with a reduced payload size. As such, the report accuracy can be improved.

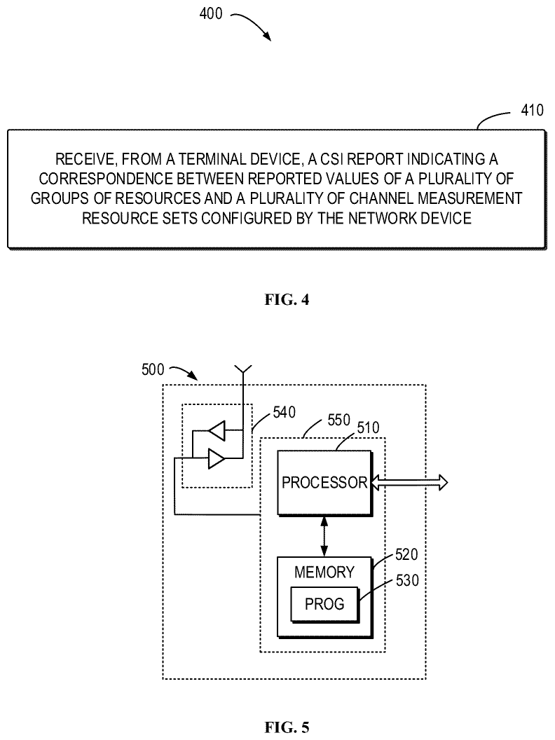

FIG. 4 illustrates a flow chart of an example method 400 of communication implemented at a network device in accordance with some embodiments of the present disclosure. The method 400 can be implemented at the network device 120 as shown in FIG. 1A. It is to be understood that the method 400 may include additional blocks not shown and/or may omit some blocks as shown, and the scope of the present disclosure is not limited in this regard.

The terminal device 110 may transmit, to the network device 120, capability information of the terminal device 110 in terms of channel measurement. For example, the capability information may indicate whether the terminal device 110 supports the CSI reporting at the level of beam pairs or groups of CSI-Rs resources.

Upon receipt of the capability information, the network device 120 may determine measurement configurations for the terminal device 110 based on the received capability information. For example, the measurement configurations may be CSI related configurations, which include but not limited to, the CMR sets, the report quantity, the report frequency configuration, CSI reporting band, time restriction for channel measurements and so on.

The network device 120 may transmit the measurement configurations for the CMR sets to the terminal device 110. For example, the transmission of the measurement configurations may be via a RRC message. The network device 120 may then transmit CSI-RSs based on the measurement configurations.

At block 410, the network device 120 receives, from the terminal device 110, a CSI report indicating a correspondence between reported values of a plurality of groups of resources and a plurality of channel measurement resource sets configured by the network device. Each of the plurality of groups may comprise resources selected from different channel measurement resource sets.

In some example embodiments, the correspondence may be indicated by a first indicator in the CSI report. The first indicator may indicate a channel measurement resource set on which a largest one of the reported values is obtained.

In some example embodiments, the correspondence may be indicated by a second indicator in the CSI report. The second indicator may indicate a target field for a largest one of the reported values.

In some example embodiments, the CSI report may comprise the following for indicating the correspondence: reported values for measurement results of resources of a first group of the plurality of groups, and reported differences between a larger one of the reported values and the rest of measurements results of resources of the plurality of the groups.

In some example embodiments, the CSI report may indicate a correspondence between the plurality of groups of resources and the reported values determined based on averaged measurement results of the plurality of groups of resources.

In some example embodiments, the CSI report may include a first part and optionally a second part. In these embodiments, the network device 120 may receive the first part of the CSI report comprising the third indicator indicating an existence of a second part of the CSI report. The first part of the CSI report may indicate a part of the reported values. The network device 120 may then receive the second part of the CSI report indicates a rest of the reported values.

In some example embodiments, the CSI report comprises the following for indicating the correspondence: a first reported value for a largest one of measurement results of each group of the resources, and a reported difference between the largest one and the rest of the measurement results on each group of the resources.

In some example embodiments, at least one of the resources may correspond to more than one of the groups, the correspondence is indicated by in the CSI report, and the plurality of fields indicates at least one reported value of a measurement result on the at least one of the resources.

In some example embodiments, the reported values may comprise at least one of the following: absolute or differential values determined based on reference signal received powers (RSRPs), reference signal received qualities (RSRQs), or signal to interference plus noise ratios (SINRs) measured from the reference signals.

According to the example embodiments of the present disclosure, there is provided a solution of beam reporting. The CSI report is improved to report multiple beam pairs and the best beam pair suitable for the multi-TRP. Moreover, the CSI report can indicate a correspondence between the groups of resources and the channel measurement resource sets with a reduced payload size. As such, the report accuracy can be improved.

FIG. 5 is a simplified block diagram of a device 500 that is suitable for implementing embodiments of the present disclosure. The device 500 can be considered as a further example implementation of the terminal device 110 or the network device 120, as shown in FIG. 1A. Accordingly, the device 500 can be implemented at or as at least a part of the terminal device 110, or the network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIGS. 2 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-23. (canceled)

24. A method of communication performed by a terminal device, the method comprising:
receiving, from a network device, information configuring a first channel measurement resource set and a second channel measurement resource set;
transmitting, to the network device, a channel state information (CSI) report comprising a field of a first indicator with a value of either 0 or 1,
wherein,
the first indicator indicates one of the first channel measurement resource set or the second channel measurement resource set from which a first resource indicator is reported,
the first resource indicator is one of a plurality of resource indicators of a first resource group,
the first resource group is one of a plurality of resource groups, and
the first resource indicator is reported from a different one of the first channel measurement resource set or the second channel measurement resource set, from which another one of the plurality of resource indicators of the first resource group is reported.

25. The method of claim 24, wherein remaining resource groups within the plurality of resource groups follow a same mapping order as the first resource group, where a primary resource indicator of each of the remaining resource groups is reported from the one of the first channel measurement resource set or the second channel measurement resource set indicated by the first indicator.

26. The method of claim 24, wherein the first resource indicator corresponds to a largest measured value of reference signal received power (RSRP).

27. The method of claim 26, wherein the largest measured value of RSRP is quantized to a 7-bit value.

28. A method of communication performed by a network device, the method comprising:
transmitting, to a terminal device, information configuring a first channel measurement resource set and a second channel measurement resource set;
receiving, from the terminal device, a channel state information (CSI) report comprising a field of a first indicator with a value of either 0 or 1,
wherein,
the first indicator indicates one of the first channel measurement resource set or the second channel measurement resource set from which a first resource indicator is reported,
the first resource indicator is one of a plurality of resource indicators of a first resource group,
the first resource group is one of a plurality of resource groups, and
the first resource indicator is reported from a different one of the first channel measurement resource set or the second channel measurement resource set, from which another one of the plurality of resource indicators of the first resource group is reported.

29. The method of claim 28, wherein remaining resource groups within the plurality of resource groups follow a same mapping order as the first resource group, where a primary resource indicator of each of the remaining resource groups is reported from the one of the first channel measurement resource set or the second channel measurement resource set indicated by the first indicator.

30. The method of claim 28, wherein the first resource indicator corresponds to a largest measured value of reference signal received power (RSRP).

31. The method of claim 30, wherein the largest measured value of RSRP is quantized to a 7-bit value.

32. A terminal device comprising:
at least one memory having stored therein program instructions;
at least one processor configured to execute the program instructions, that when executed perform operations comprising:
receiving, from a network device, information configuring a first channel measurement resource set and a second channel measurement resource set;
transmitting, to the network device, a channel state information (CSI) report comprising a field of a first indicator with a value of either 0 or 1,
wherein,
the first indicator indicates one of the first channel measurement resource set or the second channel measurement resource set from which a first resource indicator is reported,
the first resource indicator is one of a plurality of resource indicators of a first resource group,
the first resource group is one of a plurality of resource groups, and
the first resource indicator is reported from a different one of the first channel measurement resource set or the second channel measurement resource set, from which another one of the plurality of resource indicators of the first resource group is reported.

33. The terminal device of claim 31, wherein remaining resource groups within the plurality of resource groups follow a same mapping order as the first resource group, where a primary resource indicator of each of the remaining resource groups is reported from the one of the first channel measurement resource set or the second channel measurement resource set indicated by the first indicator.

34. The terminal device of claim 32, wherein the first resource indicator corresponds to a largest measured value of reference signal received power (RSRP).

35. The terminal device of claim 34, wherein the largest measured value of RSRP is quantized to a 7-bit value.
